(19) United States
(12) Patent Application Publication
(10) Pub. No.: US 2011/0018527 A1
(43) Pub. Date: Jan. 27, 2011

(54) Apparatus for detecting the travel of a lifting motor

(76) Inventor: Chen-Hui Ko, Koeishan Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,717

(22) Filed: Jul. 21, 2009

(51) Int. Cl. G01B 7/30; G01B 7/14

(52) U.S. Cl. 324/207.25

(57) ABSTRACT

An apparatus for detecting the travel of a lifting motor, comprising: a transmission unit positioned within a housing and having a reduction gearset and a transmission gear meshed with the reduction gearset; a threaded rod passing through a housing and threadedly coupled with the transmission gear. The transmission unit includes at least one magnet at one of the gears made of non-permeable material. The magnets are rotated clockwise or counterclockwise with the non-permeable gear when the transmission unit is driven by the motor in rotation. The number of rotation will be detected by a magnetic sensor disposed at the housing through the magnetic line of force generated by the magnet. Thereafter, the detection signals will be transmitted to a travel-calculation unit for measuring the linear displacement distance (travel) of the threaded rod in axial direction. In this way, the built-in detecting structure includes an integral arrangement and is easily secured to the treadmill. Moreover, the external interference may be reduced to enhance the precision and to prolong the service life.

### BACKGROUND OF THE INVENTION

1. Field of the Invention

The invention relates to an apparatus for detecting the travel of a lifting motor, and more particularly to a structure having magnets disposed at a built-in gear for detecting the number of rotation by use of the magnetic line of force, thereby determining the lifting travel.

2. Description of the Related Art

A great number of motors are existing in the market. They are differently designed according to various requirements. As shown in FIG. 1, a lifting motor 10 for a treadmill primarily includes a housing 11 in which a transmission gear (not shown) is disposed. A motor 12 is employed for providing the driving power with which the transmission gear imparts motion to a transmission rod 14 for an axial movement within a sleeve 13. In this way, the inclination of a treadmill's platform 20 relative to a base frame 30 may be adjusted. In other words, the inclination angle of the platform 20 is adjustable to meet different requirements of operators on the inclination of the platform 20. In order to control the inclination of the platform 20, a sensor (not shown) for detecting the inclination of the platform 20 is disposed at a proper place of the treadmill 40 so as to control the travel change of the lifting motor 10. Accordingly, a practical adjustment of the inclination of the platform 20 is achieved. However, this conventional lifting motor 10 must employ an external sensor to provide the measuring signals of the transmission travel change. Thereafter, the transmission may be controlled.

However, the sensor for detecting the travel change is mounted at the external side of the lifting motor 10, thereby taking much time and efforts for the installation. Moreover, the detection is easily affected by the external environment, thereby decreasing the measuring precision. In addition, it is easily damaged to affect the service life. Thus, it requires further improvements.

### SUMMARY OF THE INVENTION

An object of the invention is to provide an apparatus for detecting the travel of a lifting motor that permits a precise measurement of the transmission travel.

Another object of the invention is to provide an apparatus for detecting the travel of a lifting motor that includes a built-in sensor. In this way, the influence and the damage by the external environment may be avoided for prolonging the service life. Moreover, an integral arrangement and a convenient installation are ensured

In order to achieve the above-mentioned objects, an apparatus for detecting the travel of a lifting motor includes:

a) a housing consisting of a front housing and a rear housing;

b) a transmission unit positioned within the housing and having a reduction gearset and a transmission gear meshed with the reduction gearset;

c) a motor positioned at the external side of the housing, a driving shaft of the motor being extended into the housing for driving the reduction gearset;

d) a threaded rod passing through the housing and threadedly coupled with the transmission gear; and

e) a fixing sleeve mounted at the external side of the housing and fitting over one end of the threaded rod;

wherein the transmission unit includes at least one magnet at one of the gears made of non-permeable material, and wherein the magnets are rotated clockwise or counterclockwise with the non-permeable gear when the transmission unit is driven by the motor in rotation, and wherein the number of rotation will be detected by a magnetic sensor disposed at the housing through the magnetic line of force generated by the magnet, whereupon the detection signals will be transmitted to a travel-calculation unit for measuring the linear displacement distance (travel) of the threaded rod in axial direction.

According to the invention, the non-permeable gear is either the transmission gear or the reduction gearset of the transmission unit.

### BRIEF DESCRIPTION OF THE DRAWINGS

The accomplishment of this and other objects of the invention will become apparent from the following descriptions and its accompanying figures of which:

FIG. 1 is a perspective view of a lifting motor for a conventional treadmill;

FIG. 2 is an exploded perspective view of an apparatus in accordance with the invention;

FIG. 3 is a top view of the apparatus in accordance with the invention after assembly;

FIG. 4 is a cutaway view of the apparatus in accordance with the invention;

FIG. 5 is a perspective view of a transmission gear fitted with magnets in accordance with the invention;

FIG. 6 is a perspective view of a reduction gearset fitted with magnets in accordance with the invention;

FIG. 7 is a cross-sectional view taken along the line 7-7 in FIG. 4, showing that the magnets are positioned in the transmission gear; and

FIG. 8 is a schematic drawing of the invention, showing that the magnets are positioned in the reduction gearset.

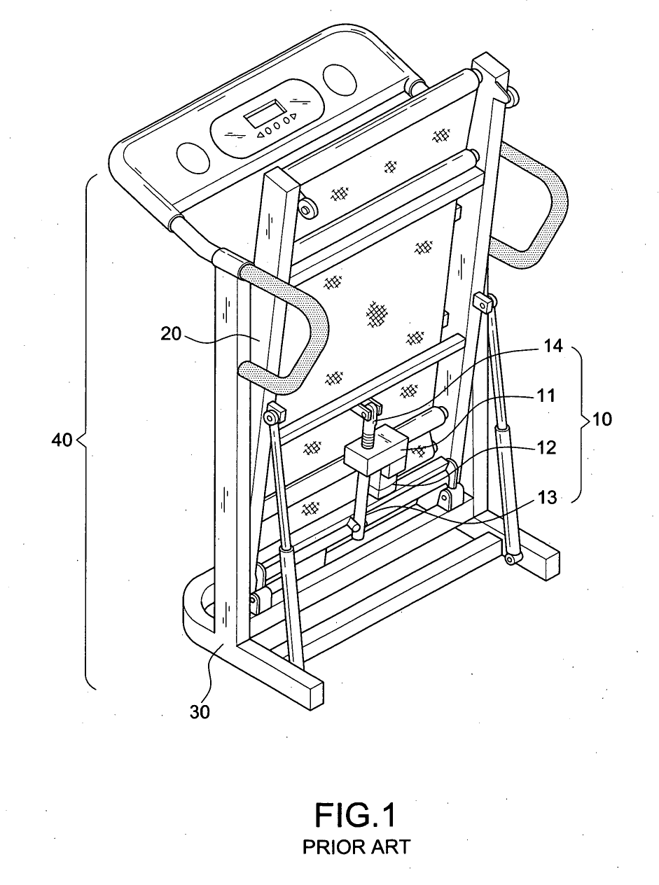

### DETAILED DESCRIPTION OF THE PREFERRED EMBODIMENT

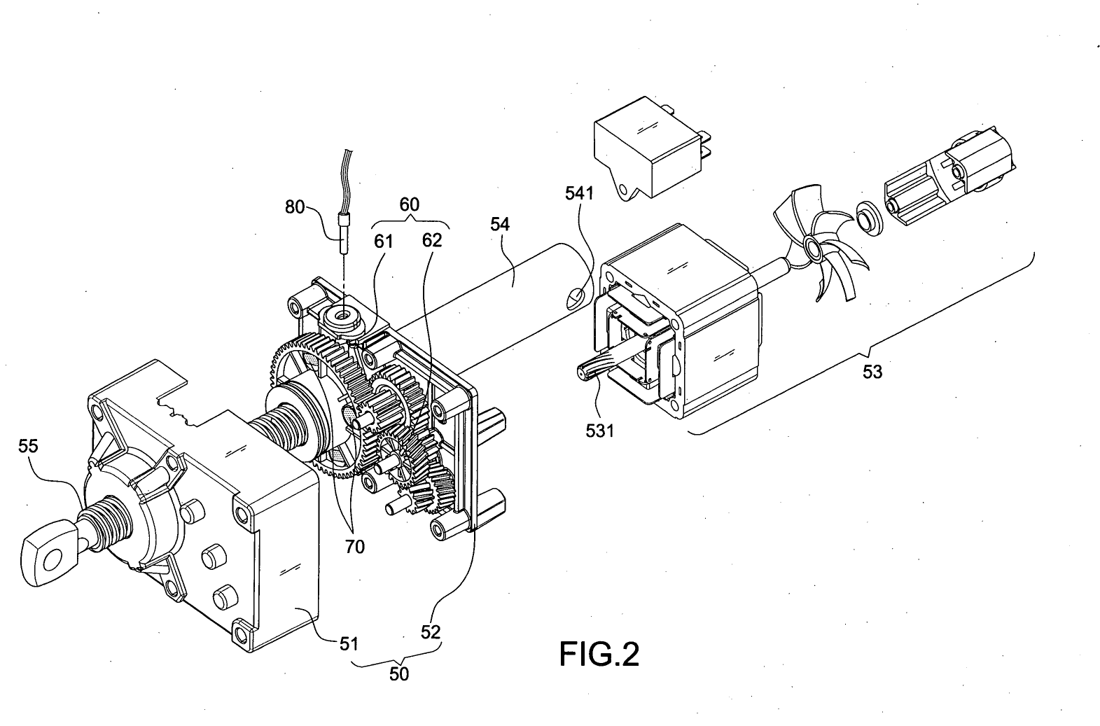

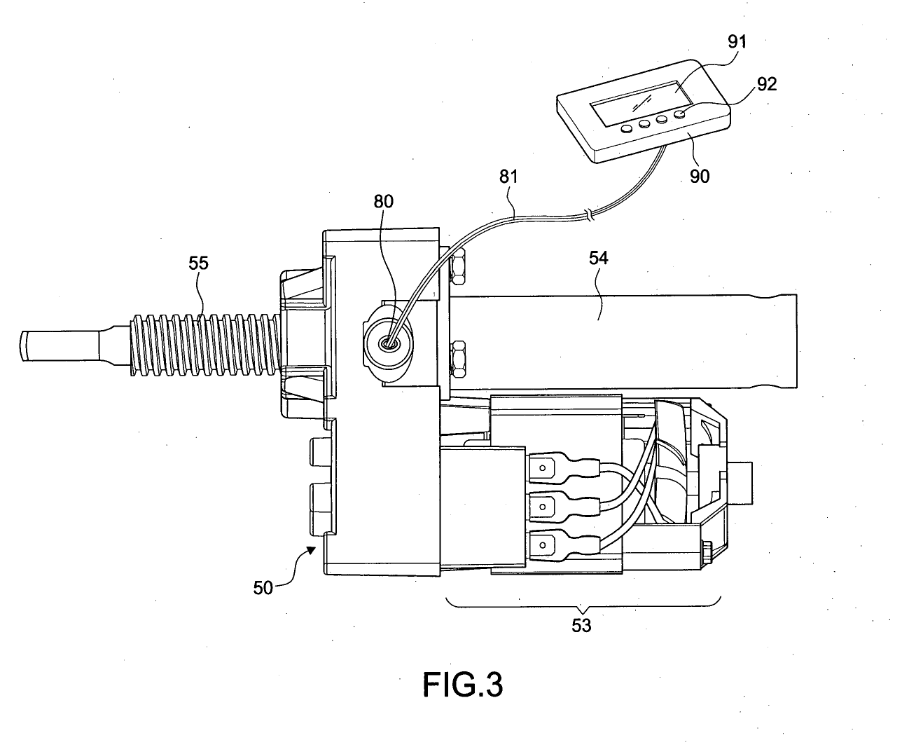

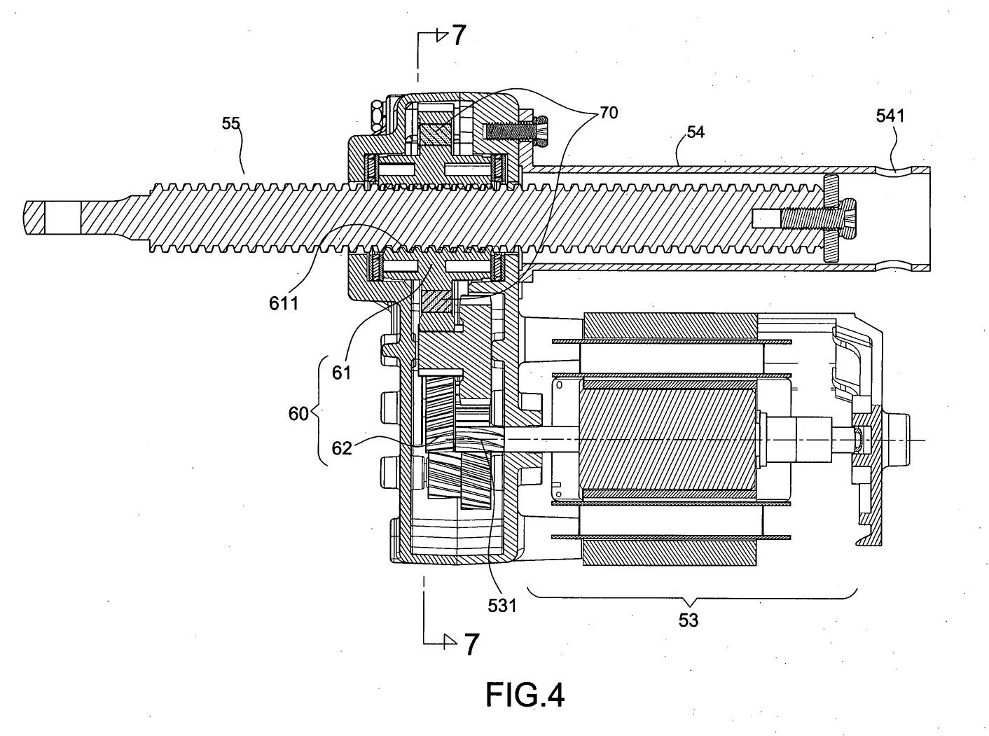

First of all, referring to FIGS. 2 through 8, an apparatus for detecting the travel of a lifting motor in accordance with the invention includes a housing 50, a transmission unit 60, a motor 53, a threaded rod 55, and a fixing sleeve 54.

The housing 50 consists of a front housing 51 and a rear housing 52. The housing 50 is made of metal or plastic material.

The transmission unit 60 is positioned within the housing 50 and includes a reduction gearset 62 and a transmission gear 61 meshed with the reduction gearset 62.

The motor 53 is positioned at the external side of the housing 50. According to this embodiment, the motor 53 is mounted on the rear housing 52. Moreover, a driving shaft 531 of the motor 53 is extended into the housing 50 for driving the reduction gearset 62.

The threaded rod 55 passes through the housing 50 and is threadedly coupled with the transmission gear 61. According to this embodiment, the center of the transmission gear 61 is provided with a thread 611 for a threaded connection with the threaded rod 55. In this way, a transmission between a threaded rod and a threaded sleeve takes place. In other words, the threaded rod 55 is linearly moved in the axial direction when the transmission gear 61 is rotated by the reduction gearset 62.

The fixing sleeve 54 is mounted at the external side of the housing 50 and fits over one end of the threaded rod 55. According to this embodiment, the fixing sleeve 54 is disposed on the rear housing 52 and arranged parallel to the motor 53. The fixing sleeve 54 is employed for providing a room when the threaded rod 55 is axially moved. In addition, the fixing sleeve 54 includes a pivotal hole 541 at the rear end thereof for a pivotal connection to an treadmill.

The object of the invention is to calculate the axial displacement or the lifting transmission travel of the threaded rod 55. As a result, the primary features of the invention are detailed as follows:

The transmission unit 60 includes at least a magnet 70 on a non-permeable gear 70. The non-permeable material includes aluminum, copper, or plastic material. The permeable material like iron should not be employed since the magnetic line of force of the magnet 70 may be affected.

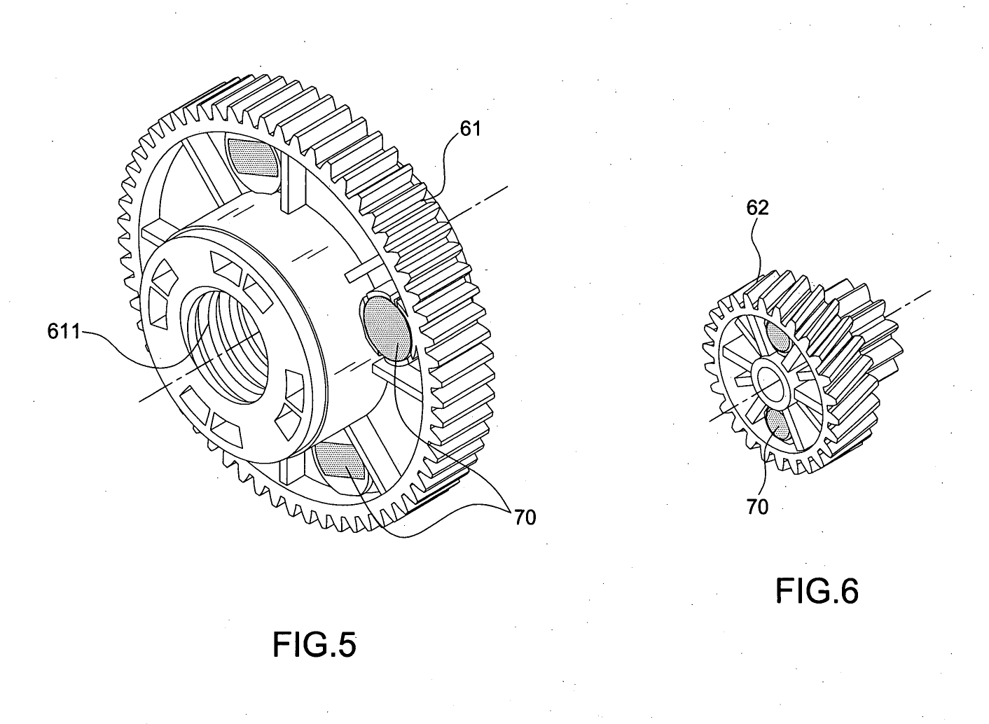

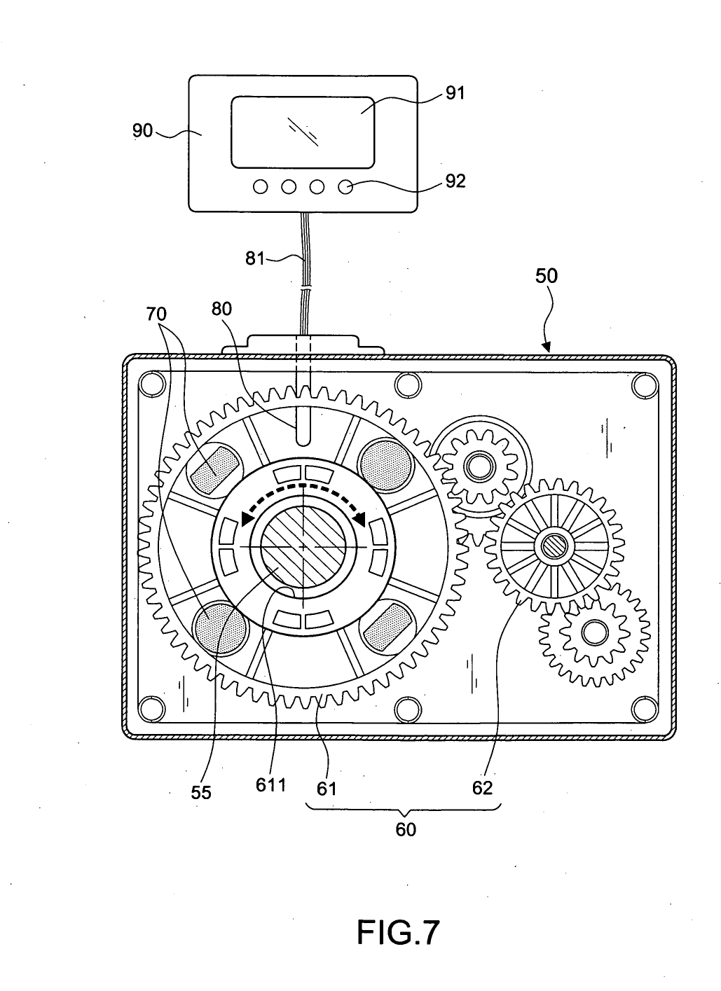

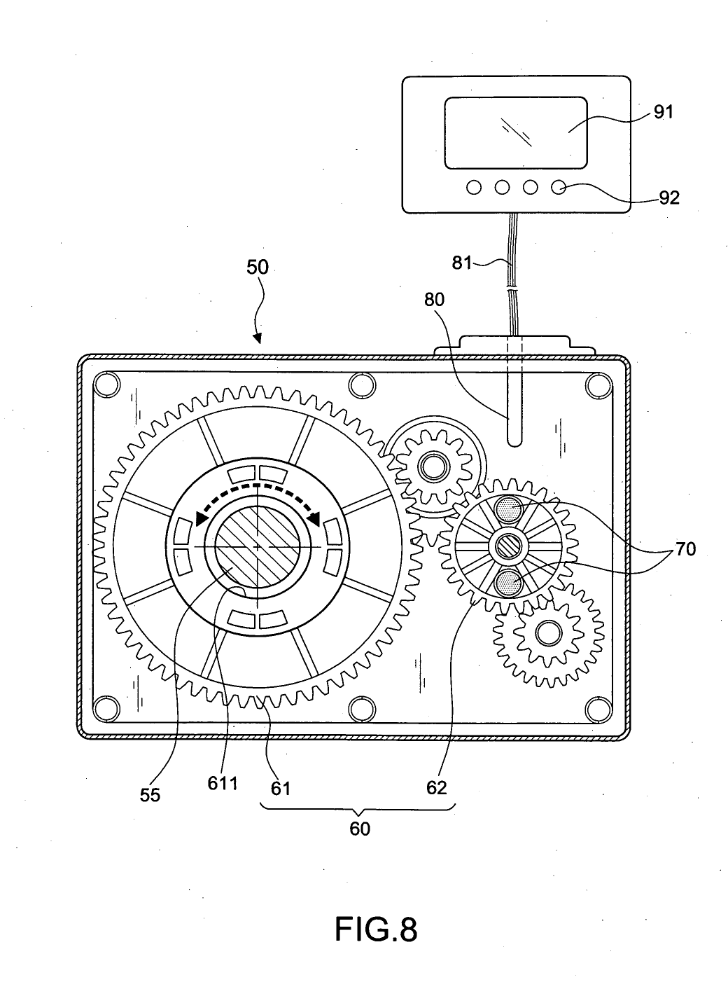

An embodiment of the invention is shown in FIGS. 5 and 7. More than one magnet 70 is positioned at the transmission gear 61 of the transmission unit 60. The transmission gear 61 is driven by the reduction gearset 62 so that the rotation thereof is decelerated. Moreover, it has a larger diameter so that it is a preferred embodiment, but should not be restricted thereto. According to another embodiment shown in FIGS. 6 and 8, the magnets 70 are positioned at the reduction gearset 62.

The transmission gear 61 and the reduction gearset 62 fitted with the magnets 70 are made of non-permeable material. Therefore, the magnetic line of force generated by the magnet 70 won't be interfered. As shown in FIGS. 7 and 8, the magnets 70 are rotated clockwise or counterclockwise with the transmission gear 61 or the reduction gearset 62 made of non-permeable material when the transmission unit 60 is driven by the motor 53 in rotation. The number of rotation will be detected by a magnetic sensor 80 disposed at the housing 50 through the magnetic line of force generated by the magnet 70. Then, the detection signals will be transmitted via a cable 81 to a travel-calculation unit 90 for measuring the linear displacement distance of the threaded rod 55 in axial direction. The linear displacement distance stands for the transmission travel.

According to this embodiment, the magnetic sensor 80 is selected from a group consisting of a solenoid or a Hall-IC (integrated circuit). The magnetic sensor 80 produces one measuring signal when the magnets 70 on the transmission gear 61 or on the reduction gearset 62 rotatingly pass through the position of the magnetic sensor 80. One measuring signal stands for one-fourth circle when four magnets 70 are mounted on the transmission gear 61. In this way, the number of rotation of the transmission gear 61 may be determined. As a result, the change of the transmission travel of the threaded rod 55 is measured according to preset parameters when the external travel-calculation unit 90 receives the signal of the number of rotation of the transmission gear 61. Moreover, the travel-calculation unit 90 may be installed at a console of the treadmill and includes a display surface 91 and an operation interface 92. In this way, the operator may conduct an adjustment according to his needs at will. In other words, the inclination of the treadmill's platform may be adjusted to achieve an operator-oriented operation.

According to the invention, the magnets 70 built within the non-permeable transmission unit 60 are employed for an accurate measurement of the lifting travel by use of the rotational detection of the magnetic line of force without the influence by the external environment. Accordingly, a reliable operation is achieved. Moreover, the complete structure is easily secured to the treadmill, thereby increasing the practicalness of the product.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An apparatus for detecting the travel of a lifting motor, comprising:
a) a housing consisting of a front housing and a rear housing;
b) a transmission unit positioned within the housing and having a reduction gearset and a transmission gear meshed with the reduction gearset;
c) a motor positioned at the external side of the housing, a driving shaft of the motor being extended into the housing for driving the reduction gearset;
d) a threaded rod passing through the housing and threadedly coupled with the transmission gear; and
e) a fixing sleeve mounted at the external side of the housing and fitting over one end of the threaded rod;
wherein the transmission unit includes at least one magnet at one of the gears made of non-permeable material, and wherein the magnets are rotated clockwise or counterclockwise with the non-permeable gear when the transmission unit is driven by the motor in rotation, and wherein the number of rotation will be detected by a magnetic sensor disposed at the housing through the magnetic line of force generated by the magnet, whereupon the detection signals will be transmitted to a travel-calculation unit for measuring the linear displacement distance (travel) of the threaded rod in axial direction.

2. The apparatus for detecting the travel of a lifting motor as recited in claim 1 wherein the non-permeable gear fitted with the magnets is the transmission gear.

3. The apparatus for detecting the travel of a lifting motor as recited in claim 1 wherein the non-permeable gear fitted with the magnets is the reduction gearset.
